(19) United States
(12) Patent Application Publication
(10) Pub. No.: US 2019/0337752 A1
(43) Pub. Date: Nov. 7, 2019

(54) VARIABLE CUTOFF IN A CUTTER FOLDER

(71) Applicant: Goss International Americas, Inc., Durham, NH (US)

(72) Inventors: Gerald Roger Douillard, Manchester, NH (US); JOHN JAMES SPOSATO, DOVER, NH (US); Jeffrey S. Upchurch, Stratham, NH (US)

(21) Appl. No.: 16/516,459

(22) Filed: Jul. 19, 2019

Related U.S. Application Data
(62) Division of application No. 13/862,807, filed on Apr. 15, 2013, now abandoned.
(60) Provisional application No. 61/625,429, filed on Apr. 17, 2012.

(51) Int. Cl. B65H 35/08; B26D 5/02; B26D 1/40; B41F 13/62; B41F 13/60; B41F 13/58

(52) U.S. Cl. CPC B65H 35/08; B26D 5/02; B26D 1/405; Y10T 83/05; B41F 13/60; B41F 13/58; Y10T 83/4838; B41F 13/62

(57) ABSTRACT

A folder for a printing press includes a cutting cylinder assembly having at least two knife and anvil cylinder sets positioned near the cutting region of a folder. The cutting cylinder assembly slides or actuates one of the knife and anvil cylinder sets into a cutting position for a desired cut length. The web passes between the knife and anvil cylinder set and is cut. When the cut length needs to be changed, the assembly is relocated to such a position that a second or further set of knife and anvil cylinders is aligned with the web.

This application claims priority to U.S. Provisional Application Ser. No. 61,625,429, filed Apr. 17, 2012, the entire disclosure of which is hereby incorporated by reference.

The present invention relates generally to printing press equipment and more particularly to cutting devices and cutting folders.

### BACKGROUND

U.S. Pat. No. 5,865,082, hereby incorporated by reference herein, discloses a first conveyor assembly and a second conveyor assembly. Cooperating cutting cylinders having a knife and an anvil are integrated into paths of the conveying elements of the first and second conveyor assemblies, seizing a web of material prior to a cutting operation.

U.S. Pat No. 6,684,746, hereby incorporated by reference herein, discloses cutting a web by linearly moving a plurality of cutting elements in a same direction as web in a signature formation area and cutting the web with the cutting elements to form signatures. A length of the signatures is varied by varying the spacing between the cutting elements in the signature formation area.

U.S. Pat. No. 8,104,755, hereby incorporated by reference herein, discloses an adjustable delivery web conversion apparatus. A variable cutoff printing unit prints pages on a web is slit into ribbons. A cutting apparatus cuts the ribbons into signatures. A controller controls the cutting apparatus based on the printing by the variable cutoff printing unit so the pages are properly positioned on the signatures.

### SUMMARY OF THE INVENTION

Typically, individual products have dedicated folder deliveries which accommodate the characteristics of the associated products. Other deliveries accommodate variable cut lengths of products by increasing the speed of the cutting cylinders relative to the web in order to shorten the length of the product or decreasing the speed of the cutting cylinders relative to the web in order to increase the length of the product. However, the speed of the knife blades on the cutting cylinder may cause performance issues and product damage.

In the past, discrete cut length changes may have been done by removing and replacing the cutting cylinder cassette assembly. This is a very time consuming process that may take a day to change. Damage may also occur while removing or installing the cassette assembly.

An object of the present invention provides discrete cut length changes of a product by sliding cutting cylinders sets of different diameters and/or knife arrangements into and out of the web path in a folder. This allows the production of 203 mm, 244 mm and 305 mm products from a 1220 mm blanket circumference.

Another object of the present invention provides cutting cylinder sets which can change speeds relative to the web in order to produce discrete sizes within a 10 mm range. For example, product lengths varying between 305 mm and 315 mm may be cut by rotating the 315 mm size cutting cylinder set faster relative to the web speed.

The present invention provides a folder for a printing press including: a cutting cylinder assembly having at least two knife and anvil cylinder sets positioned near the cutting region of a folder. The cutting cylinder assembly slides or actuates one of the knife and anvil cylinder sets into a cutting position for a desired cut length. The web passes between the knife and anvil cylinder set and is cut. When the cut length needs to be changed, the assembly is relocated to such a position that a second or further set of knife and anvil cylinders is aligned with the web.

In accordance with a first embodiment of the present invention, a folder for a printing press is provided. The folder includes a movable assembly which includes a first cutting cylinder pair including a first knife cylinder and a first anvil cylinder for cutting a web into signatures, and a second cutting cylinder pair including a second knife cylinder and a second anvil cylinder for cutting the web into signatures. The movable assembly supports the first cutting cylinder pair and second cutting cylinder pair, and the assembly is movable to selectively position either the first cutting cylinder pair or the second cutting cylinder pair into a cutting position for cutting the web.

The aforementioned embodiment may also include other optional components and features. For example, the following features may be included, in any combination:

In accordance with a further aspect of the first embodiment, the movable assembly maybe movable perpendicular to a transport path of the web. The folder may include one or more rails, and wherein the movable assembly is movable perpendicular to a transport path of the web on the one or more rails. Alternatively, a linear bearing or bushing may be provided, wherein the movable assembly is movable perpendicular to a transport path of the web via the linear bearing or bushing.

In accordance with another aspect of the first embodiment, an actuator is coupled to the movable assembly, the actuator moving the movable assembly to selectively position either the first cutting cylinder pair or the second cutting cylinder pair into a cutting position for cutting the web. The actuator may, for example, be one of a hydraulic actuator, a pneumatic actuator, and a motor.

In accordance with another aspect of the first embodiment, a former, provided upstream of the movable assembly, is arranged to impart a longitudinal fold to a web. A plurality of guide belts is provided downstream of the movable assembly, the plurality of guide belts are arranged to receive the cut web from the movable assembly, and the moveable assembly is movable perpendicular to a web path of the web.

In accordance with another aspect of the first embodiment, the first knife cylinder includes a first, second, third and fourth knife box positions, the first and third knife box positions equally spaced apart from each other around a circumference of the first knife cylinder. The first, second, and fourth knife box positions are equally spaced apart from each other around the circumference.

The first anvil cylinder may include a first, second, third and fourth anvil positions, the first and third anvil positions equally spaced apart from each other around a circumference of the first anvil cylinder, and the first, second, and fourth anvil positions equally spaced apart from each other around the circumference. The second knife cylinder may include a first knife box and a second knife box equally spaced apart from each other around a circumference of the second knife cylinder, and the second anvil cylinder may include a first anvil and a second anvil equally spaced apart from each other around a circumference of the second anvil cylinder The first and third knife box positions may each have removably secured therein a knife box, and the first and third anvil positions may each have removably secured therein an anvil, so that the first cutting cylinder pair provides four cuts for each revolution of a plate cylinder of the printing press. In order to provide six cuts for each revolution of a plate cylinder of the printing press, the first, second and fourth knife box positions may each have removably secured therein a knife box, and the first, second and fourth anvil positions may each have removably secured therein an anvil. A filler piece can be provided in anvil or knife box positions when no anvil or knife box is present.

In accordance with a second embodiment of the present invention, a method of cutting a web into variable length signatures is provided which includes the steps of: (a) supporting a first cutting cylinder pair and a second cutting cylinder pair with an assembly; (b) positioning either the first cutting cylinder pair or second cutting cylinder pair into a cutting position with respect to the web; (c) cutting the web into signatures using the positioned cylinder pair; (d) repositioning the first and/or second cylinder pairs so the other cutting pair is in a cutting position with respect to the web; and (e) cutting the web into signatures using the other positioned cylinder pair.

The aforementioned embodiment may also include other optional steps. For example, the following additional steps may be included:

In accordance with another aspect of the second embodiment, the step of positioning includes moving the assembly perpendicular to a transport path of the web.

In accordance with another aspect of the second embodiment, the step of cutting the web into signatures using the positioned cylinder pair includes providing four cuts per revolution of a plate cylinder of a printing press located upstream of the assembly.

In accordance with another aspect of the second embodiment the step of cutting the web into signatures using the positioned cylinder pair includes providing six cuts per revolution of a plate cylinder of a printing press located upstream of the assembly.

In accordance with another aspect of the second embodiment, the step of cutting the web into signatures using the other positioned cylinder pair includes providing five cuts per revolution of the plate cylinder of the printing press located upstream of the assembly.

In accordance with another aspect of the second embodiment, the method comprises, after either step (c) or step (e): (f) cutting the web into signatures using the positioned cylinder pair, the positioned cylinder pair providing six cuts per revolution of the plate cylinder of the printing press located upstream of the assembly.

Further, the first knife cylinder may include a first, second, third and fourth knife box positions, where the first and third knife box positions are equally spaced apart from each other around a circumference of the first knife cylinder, and the first, second, and fourth knife box positions are equally spaced apart from each other around the circumference. During step (c), the first and third knife box positions each have removably secured therein a knife box and before step (f), the method may include removing the knife box from the third knife position, and removably securing in each of the second and fourth knife positions a respective knife box.

### BRIEF DESCRIPTION OF THE DRAWINGS

The invention will be better understood from a reading of the following description, given purely by way of example, with reference to the appended drawings, in which:

FIG. 1 shows a schematic representation of a printing press including a cutting folder according to the present invention.

FIG. 2a illustrates the cutting assembly of the folder of FIG. 1 configured to provide 4 or 5 cuts per plate cylinder revolution

FIG. 2b illustrates the cutting assembly of the folder of FIG. 1 configured to provide 6 or 5 cuts per plate cylinder revolution.

### DETAILED DESCRIPTION

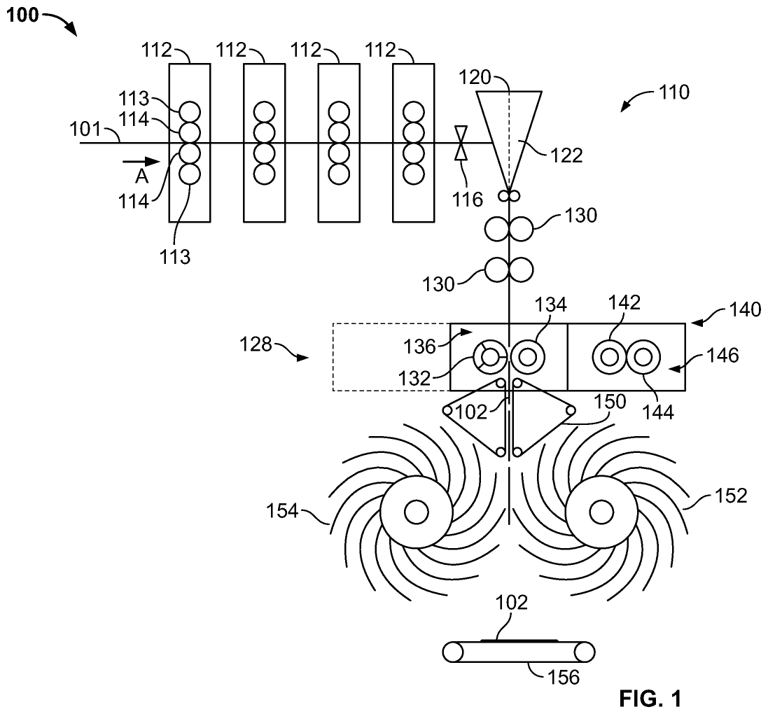

FIG. 1 shows a schematic representation of a printing press including a folder in accordance with the present invention. Printing press 100 may be, for example, a four color web offset printing press. Printing units 112 may each include two print couples, each couple including a plate cylinder 113 and a blanket cylinder 114. Each couple prints on either side of a web 101. Each print unit 112 may print a different a color, for example, magenta, cyan, yellow or black.

After printing, web 101 may be slit into a plurality of ribbons by a slitter 116, if desired. The ribbons may be combined and transported to a former 120 for longitudinal folding. The former fold 122 is in line with a direction of travel A of web 101. Printing press 100 may include a folder 110 for folding, cutting and processing web 101 into signatures 102. Folder 110 may be a pinless former folder, for example.

Folded web 101 may be transported through a plurality of nip rolls 130 to a cutting section 128 of folder 110. Cutting section 128 may include an assembly 140 supporting two pairs of cutting cylinders 136, 146. Each cutting cylinder pair 136, 146 includes a respective knife cylinder 132, 142 and a corresponding anvil cylinder 134, 144. The assembly 140 is positioned with respect to web 101 so either first cutting cylinder pair 136 or second cutting cylinder pair 146 is in a cutting position with respect to web 101. As shown in FIG. 1, first cutting cylinder pair 136 is in position with respect to web 101. The dashed line outlines a second position of assembly 140 which would align second cutting cylinder pair 146 into a cutting position with respect to web 101.

Web 101 is then cut by cutting cylinder pair 136. Cutting cylinder pair 136 may include, for example, three knives and cut web 101 into signatures have a length of 203.33 mm each.

Second knife cylinder 142 may have a different diameter than first cutting cylinder 132 and may include two or three knives, for example. Anvil cylinders 134, 144 include cutting rubbers for the knives to cut against.

Knife cylinders 132, 142 may be designed to accommodate a number of knives. For example, knife cylinders 132, 142 may include four knife box positions. However, for a specific cutting job, only two knife box positions may include knives. The other two knife box positions may include a filler piece. For a subsequent cutting job, one or both of the filler pieces may be removed and additional knives may be installed. Thus, knife cylinders 132, 142 may support two equally spaced knives or three equally spaced knives for example.

For example, referring to FIG. 1, cutting cylinder pair 136 may be configured to provide an even number of cuts per plate cylinder revolution whereas cutting cylinder pair 146 may be configured to provide an odd number of cuts per plate cylinder revolution. Further, cylinder pair 136 may be configured with different numbers of cutting knives/anvil rubbers to provide further variability. For example, cutting cylinder 132 may be configured to hold 2 knife boxes equally spaced apart around the cutting cylinder circumference to provide 4 cuts per plate cylinder revolution, and may be configured to hold 3 knife boxes equally spaced apart around the cutting cylinder circumference to provide 6 cuts per plate cylinder revolution. Cutting cylinder pair 146 may be configured to provide 5 cut per plate cylinder revolution.

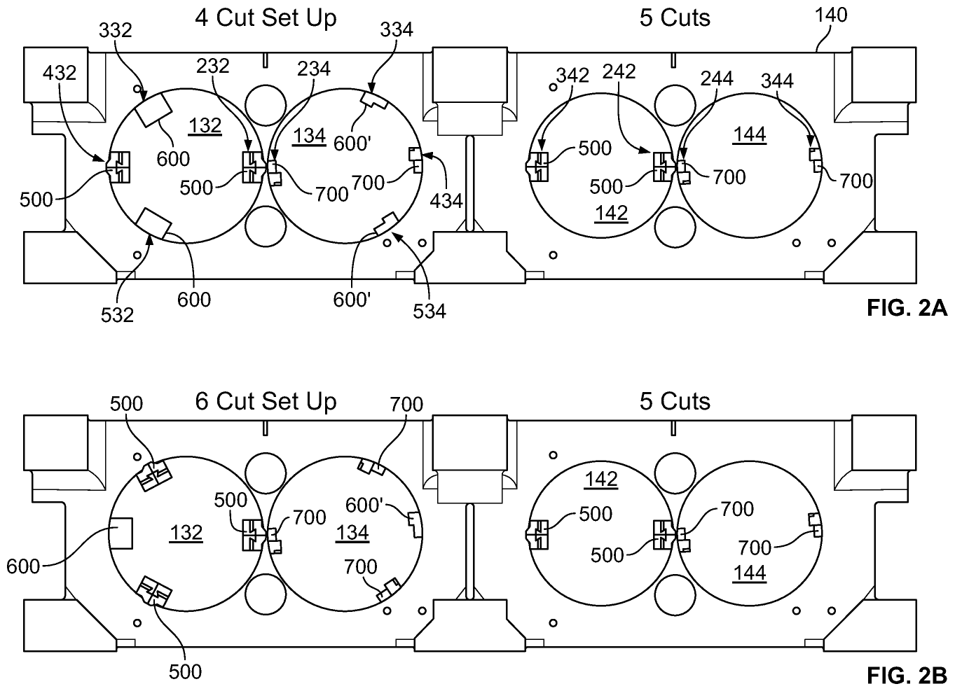

FIGS. 2(a) and 2(b) shows cutting cylinder pair 136 configured to provide 4 cuts per plate cylinder revolution and 6 cuts per plate cylinder revolution respectively. Cutting cylinder pair 146 provides 5 cuts per plate cylinder revolution. Cutting cylinder 132 of cylinder pair 136 has four knife box positions 232, 332, 432, and 532 which can each be configured to hold a knife box 500 or a filler piece 600. Anvil cylinder 134 includes four anvil rubber positions 234, 334, 434, 534, which can each be configured to hold an anvil rubber 700 or a filler piece 600′. Knife box positions 232, 332, and 532 are equally spaced apart from each other around the cylinder circumference. Moreover, knife box positions 232, 432 are equally spaced apart from each other around the cylinder circumference. Knife boxes 500 and filler pieces 600 can be removably secured to the cylinder 132 at positions 232, 332, 432, and 532. Anvil rubbers 700 and filler pieces 600′ can be removably secured to the cylinder 134 at positions 234, 334, 434, and 534.

Cutting cylinder 142 of cylinder pair 146 has two knife box positions 242, 342 equally spaced apart around the cylinder circumference, each holding a knife box 500. Anvil cylinder 144 includes two anvil rubber positions 244, 344 equally spaced apart around the cylinder circumference, each holding an anvil rubber 700. Knife boxes 500 can be permanently or removably secured to the cylinder 142 at positions 242, 342. Anvil rubbers 700 can be permanently or removably secured to the cylinder 144 at positions 244, 344. The aforementioned components can be removed and secured with fasteners or in any known or desired manner.

In FIG. 2(a), cutting cylinder 132 has been configured to includes knife boxes 500 in knife box positions 232 and 432 to provide two knife boxes equally spaced apart around the cylinder circumference. Anvil cylinder 134 have similarly be configured each include two anvil rubbers 700 in anvil rubber positions 234 and 334. Although anvils 700 are typically made of natural or synthetic rubber, and are thus referred to in the art as “anvil rubbers”, and that convention is used herein for convenience, any suitable material can be used therefore. Positions 332 and 532 include filler pieces 600, and positions 334 and 534 include filler pieces 600′. Due to the difference in circumference and/or rotational speed between cylinders 132,134 of cylinder pair 136, and cylinders 142,144 of cylinder pair 146, cutting cylinder pair 136 will provide 4 cuts per plate cylinder revolution whereas cutting cylinder pair 146 will provide 5 cuts per plate cylinder revolution. As discussed above, assembly 140 is moveable so that either cylinder pair 136 or cylinder pair 146 can be positioned in the path of web 101 to cut the web into signatures.

In FIG. 2(b), cutting cylinder 136 has been configured to include knife boxes 500 in knife box positions 232, 432, and 532. To accomplish this change in configuration from FIG. 2(a) to FIG. 2(b): the knife box 500 is removed from knife box position 432 and replaced with a filler piece 600; the filler pieces 600 are removed from knife box positions 332 and 532 and replaced with knife boxes 500; the anvil 700 is removed from anvil position 434 and replaced with a filler piece 600′; and the filler pieces 600′ are removed from anvil positions 334 and 534 and replaced with anvils 700. In the configuration of FIG. 2(b) cutting cylinder pair 136 will provide 6 cuts per plate cylinder revolution whereas cutting cylinder pair 146 will provide 5 cuts per plate cylinder revolution.

The present invention can be used with most “double around” long grain or short grain print unit sizes. It may also be used with one-around print units. Set forth in the table below are examples of product mixes that are possible for a variety of common printing press cut-offs. It should be noted that each row corresponds to a given assembly 140 with cylinders 132, 134, 142, 144 having sizes selected for the referenced cut-off. In other words, the cylinders 132, 134, 142, and 144 would be manufactured in different sizes for a 610 mm cut-off than for a 630 mm cutoff. The particular sizes required for a given cut-off are a matter of simple geometry and will not be discussed herein:

TABLE 1

| | | Spine Length by No. of Cuts per Plate Rev (mm) | | | |
|---|---|---|---|---|---|
| Nom. Cutoff (mm)(in) | Plate Circ (mm) | 3 | 4 | 5 | 6 |
| 435 | 870 | 290.0 | 217.5 | | |
| 445 | 890 | 296.7 | 222.5 | | |
| 470 | 940 | 313.3 | 235.0 | | |
| 484 | 968 | | 242.0 | | |
| 533.4 (21.0) | 1066.8 | | 266.7 | 213.4 | |
| 546.1 (21.5) | 1092.2 | | 273.1 | 218.4 | |
| 565.15 (22.25) | 1130.3 | | 282.6 | 226.1 | |
| 577.85 (22.75) | 1155.7 | | 288.9 | 231.1 | |
| 590 | 1180 | | 295.0 | 236.0 | |
| 610 | 1220 | | 305.0 | 244.0 | 203.3 |
| 620 | 1240 | | 310.0 | 248.0 | 206.7 |
| 630 | 1260 | | 315.0 | 252.0 | 210.0 |
| 638.35 (25.132) | 1276.7 | | | 255.3 | 212.8 |
| 666.75 (26.25) | 1333.5 | | | 266.7 | 222.3 |

Accordingly, for a nominal cutoff of 435 mm, an apparatus according to the present invention could generate 3 cuts per plate cylinder rotation to provide 290 mm signatures with cylinder pair 146 and 4 cuts per plate cylinder rotation to provide 217.5 mm signatures with cylinder pair 136 configured as show in FIG. 2(a). For a nominal cut-off of 610 mm, an apparatus constructed according to the present invention could generate 5 cuts per plate cylinder rotation to provide 244 mm signatures with cylinder pair 146, and 4 cuts per plate cylinder rotation to provide 305 mm signatures with a cylinder pair 136 configured as shown in FIGS. 2(a), and 6 cuts per plate cylinder rotation to provide 203.3 mm signatures with the cylinder pair 136 configured as shown in FIG. 2(b).

Assembly 140 may be a linear rail set, a set of V rails, or a flat track. When assembly 140 moves, a lock down is released, the movement is actuated by, for example, hydraulic cylinders. Air cylinders or motor(s) may also be used. Assembly 140 is then moved into the proper cutting position and locked into place. Other components of folder 110 or cutting section 128 may need to be temporarily repositioned or relocated in order to provide sufficient clearance for moving and repositioning assembly 140.

With regard to movement of the assembly, the assembly 140 may for example, have extendable or retractable wheels. When the assembly 140 is to be moved, the wheels extend, the assembly is moved along the rails or track under the control of a motor, hydraulic cylinder, or pneumatic cylinder. When assembly 140 is in place, the wheels retract thereby fixing the assembly in position. Locating devices, such as pin/hole combinations, can be used to ensure that the assembly is in the proper position. Linear slide mechanisms, such as linear bearings or bushings may alternatively be used. Such mechanisms would not employ the retractable wheels, and would not necessarily need locating devices.

Cutting cylinder pairs 136, 146 may be driven independently to allow variation in the cut off length. Assembly 140 may also support the drive necessary to rotate the cylinders, for example, a gear train, a belt drive or individual motors.

Tapes, for example, tapes 150 may support web 101 and signatures 102 cut therefrom. Fan cylinders 152, 154 may receive signatures 102 and deposit signatures 102 on conveyor 156 for further processing. Fan delivery is product length sensitive. A tail belt registers the signatures 102 against the strippers. The strippers force the signature out of the fan pocket. The signature then lands on the delivery belts 156. Conventional mechanisms allow quick make-ready adjustments to the belt and stripper to accommodate quick changes in product length, and therefore will not be discussed herein.

In the foregoing specification, the invention has been described with reference to specific exemplary embodiments thereof. It will, however, be evident that various modifications and changes may be made without departing from the broader spirit and scope of the invention as set forth in the appended claims. The specification and drawings are accordingly to be regarded in an illustrative rather than a restrictive sense.

1. A folder for a printing press comprising:
a movable assembly including
a first cutting cylinder pair including a first knife cylinder and a first anvil cylinder for cutting a web into signatures, and
a second cutting cylinder pair including a second knife cylinder and a second anvil cylinder for cutting the web into signatures;
the movable assembly supporting the first cutting cylinder pair and second cutting cylinder pair, the assembly movable to selectively position either the first cutting cylinder pair or the second cutting cylinder pair into a cutting position for cutting the web.

2. The folder of claim 1, wherein the movable assembly is movable perpendicular to a transport path of the web.

3. The folder of claim 1, further comprising one or more rails, and wherein the movable assembly is movable perpendicular to a transport path of the web on the one or more rails.

4. The folder of claim 1, further comprising a linear bearing or bushing, and wherein the movable assembly is movable perpendicular to a transport path of the web via the linear bearing or bushing.

5. The folder of claim 1, further comprising an actuator, the actuator coupled to the movable assembly, the actuator moving the movable assembly to selectively position either the first cutting cylinder pair or the second cutting cylinder pair into a cutting position for cutting the web.

6. The folder of claim 5, wherein the actuator is one of a hydraulic actuator, a pneumatic actuator, and a motor.

7. The folder of claim 1, further comprising:
a former, upstream of the movable assembly, arranged to impart a longitudinal fold to a web;
a plurality of guide belts, downstream of the movable assembly, the plurality of guide belts arranged to receive the cut web from the movable assembly;
wherein the moveable assembly is movable perpendicular to a web path of the web.

8. The folder of claim 1, wherein the first knife cylinder includes a first, second, third and fourth knife box positions, the first and third knife box positions equally spaced apart from each other around a circumference of the first knife cylinder, the first, second, and fourth knife box positions equally spaced apart from each other around the circumference.

9. The folder of claim 8, wherein the first anvil cylinder includes a first, second, third and fourth anvil positions, the first and third anvil positions equally spaced apart from each other around a circumference of the first anvil cylinder, the first, second, and fourth anvil positions equally spaced apart from each other around the circumference.

10. The folder of claim 9, wherein the second knife cylinder includes a first knife box and a second knife box equally spaced apart from each other around a circumference of the second knife cylinder, and the second anvil cylinder includes a first anvil and a second anvil equally spaced apart from each other around a circumference of the second anvil cylinder.

11. The folder of claim 9, wherein the first and third knife box positions each have removably secured therein a knife box, and the first and third anvil positions each have removably secured therein an anvil, wherein the first cutting cylinder pair provides four cuts for each revolution of a plate cylinder of the printing press.

12. The folder of claim 9, wherein the first, second and fourth knife box positions each have removably secured therein a knife box, and the first, second and fourth anvil positions each have removably secured therein an anvil, wherein the first cutting cylinder pair provides six cuts for each revolution of a plate cylinder of the printing press.

13. The folder of claim 11, further comprising a motor, the motor driving the first cutting cylinder pair.

14 to 20. (canceled)
